(19) United States
(12) Patent Application Publication
(10) Pub. No.: US 2025/0140467 A1
(43) Pub. Date: May 1, 2025

(54) INDUCTIVE STRUCTURE

(71) Applicant: PHOENIX PIONEER TECHNOLOGY CO., LTD., Hsinchu County (TW)

(72) Inventor: Pao-Hung CHOU, Hsinchu County (TW)

(73) Assignee: PHOENIX PIONEER TECHNOLOGY CO., LTD., Hsinchu County (TW)

(21) Appl. No.: 18/927,779

(22) Filed: Oct. 25, 2024

(30) Foreign Application Priority Data
Oct. 26, 2023 (TW) 112141123

(51) Int. Cl. H01F 27/28; H01F 27/24

(52) U.S. Cl. CPC H01F 27/2804; H01F 27/24

(57) ABSTRACT

Provided is an inductive structure in which an inductive body and a magnetic core structure having a plurality of vias are embedded in an insulator to enhance the bonding force between the magnetic core structure and the insulator by means of the vias. Therefore, the inductive structure of the present disclosure is able to avoid the occurrence of peeling off phenomenon.

### BACKGROUND

### 1. Technical Field

The present disclosure relates to an inductive structure, and more particularly, an inductive structure having a magnetic core.

### 2. Description of Related Art

With the booming development of the electronics industry and the evolution of packaging technology, the size or volume of semiconductor packages are also constantly shrinking, thereby making the semiconductor packages thin, light and compact. Currently, the substrates of semiconductor packages used in electronic products, such as the carrier board of cell phone chips, lens module circuit boards or coil boards, etc., are designed with magnetic cores to increase the magnetic flux of the substrates, thereby enhancing the performances of the substrates.

FIG. 1A is a schematic cross-sectional view of a conventional art coil substrate 1a with a horizontal winding structure, and FIG. 1B is a schematic cross-sectional view of a conventional coil substrate 1b with a vertical winding structure. As shown in FIG. 1A and FIG. 1B, the conventional coil substrate 1a, 1b includes a package layer 10a, 10b, a coil structure 11a, 11b and a magnetic core 12a, 12b embedded in the package layer 10a, 10b, and a plurality of electrode pads 13a, 13b connected to the coil structure 11a, 11b and providing for external electrical connection.

Moreover, the coil structure 11a, 11b surrounds a center axis C and is embedded in the package layer 10a, 10b, and the magnetic core 12a, 12b are embedded in the package layer 10a, 10b along the center axis C such that the coil structure 11a, 11b is disposed in the package layer 10a, 10b around the magnetic core 12a, 12b.

However, in the existing technology, due to the poor bonding between the magnetic core 12a, 12b and the package layer 10a, 10b in the conventional coil substrate 1a, 1b, the magnetic core 12a, 12b and the package layer 10a, 10b are subjected to peeling off, which results in a significant decrease in the process yield of the conventional coil substrate 1a, 1b.

Therefore, how to overcome the various problems of the above-mentioned prior art has become an urgent issue for the industry to be solved.

### SUMMARY

In view of the various deficiencies of the prior art, the present disclosure provides an inductive structure. The inductive structure comprises: an insulator having a first side and a second side opposing the first side; an inductive body which is a spiral coil embedded in the insulator; and a magnetic core structure having a plurality of vias and embedded in the spiral coil of the inductive body within the insulator, wherein the plurality of vias extend in a direction of a connection line between the first side and the second side of the insulator and penetrate the magnetic core structure.

In the aforementioned inductive structure, the magnetic core structure has a rectangular, circular, symmetrical polygonal or irregular polygonal projected profile on the first side and/or the second side of the insulator.

In the aforementioned inductive structure, the magnetic core structure is stacked in a plurality of layers at intervals, and the layers are not electrically connected to each other.

In the aforementioned inductive structure, the inductive body is a spiral coil wound horizontally or vertically.

In the aforementioned inductive structure, the inductive body comprises a plurality of inductive circuit layers spaced apart from each other and at least a conductor connecting adjacent inductive circuit layers, and two outer ends of the plurality of inductive circuit layers have external electrical contacts respectively.

In the aforementioned inductive structure, the present disclosure further comprises a first conductive pillar and a second conductive pillar embedded in the insulator and respectively connected to the two external electrical contacts, wherein at least one end of the first conductive pillar is exposed to one surface of the first side or the second side of the insulator, and at least one end of the second conductive pillar is exposed to one surface of the first side or the second side of the insulator.

In the aforementioned inductive structure, the plurality of inductive circuit layers are in a form of a single-stranded spiral coil.

In the aforementioned inductive structure, the plurality of inductive circuit layers are in a form of multiple spiral coils.

In the aforementioned inductive structure, ends of the plurality of inductive circuit layers are connected.

In the aforementioned inductive structure, ends of the plurality of inductive circuit layers are separated.

As can be seen from the above, the inductive structure of the present disclosure is mainly formed by the formation of a plurality of vias in the magnetic core structure. Therefore, compared to the conventional technology, the present disclosure enhances the bonding force between the magnetic core structure and the insulator by means of the magnetic core structure with the plurality of vias, thus avoiding the peeling off phenomenon of the inductive structure.

### BRIEF DESCRIPTION OF THE DRAWINGS

FIG. 1A is a schematic cross-sectional view of a conventional coil substrate with a horizontal winding structure.

FIG. 1B is a schematic cross-sectional view of a conventional coil substrate with a vertical winding structure.

FIG. 2 is a schematic cross-sectional view showing an inductive structure according to a first embodiment of the present disclosure.

FIG. 2A, FIG. 2B and FIG. 2B-1 are schematic plan view showing inductive circuit layers and a magnetic core structure of FIG. 2.

FIG. 2C is a schematic cross-sectional view of another aspect of FIG. 2.

FIG. 2D-1 to FIG. 2D-4 show projected profiles of a magnetic core structure on a first side of an insulator according to the present disclosure.

FIG. 3 is a schematic cross-sectional view showing an inductive structure according to a second embodiment of the present disclosure.

FIG. 3A, FIG. 3B and FIG. 3B-1 are schematic plan view showing inductive circuit layers and a magnetic core structure of FIG. 3.

FIG. 3C is a schematic cross-sectional view of another aspect of FIG. 3.

### DETAILED DESCRIPTION

The following describes the implementation of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “on,” “first,” “second,” “a,” “one” and the like used herein are merely used for clear explanation rather than limiting the practicable scope of the present disclosure, and thus, alterations or adjustments of the relative relationships thereof without essentially altering the technical contents should still be considered in the practicable scope of the present disclosure.

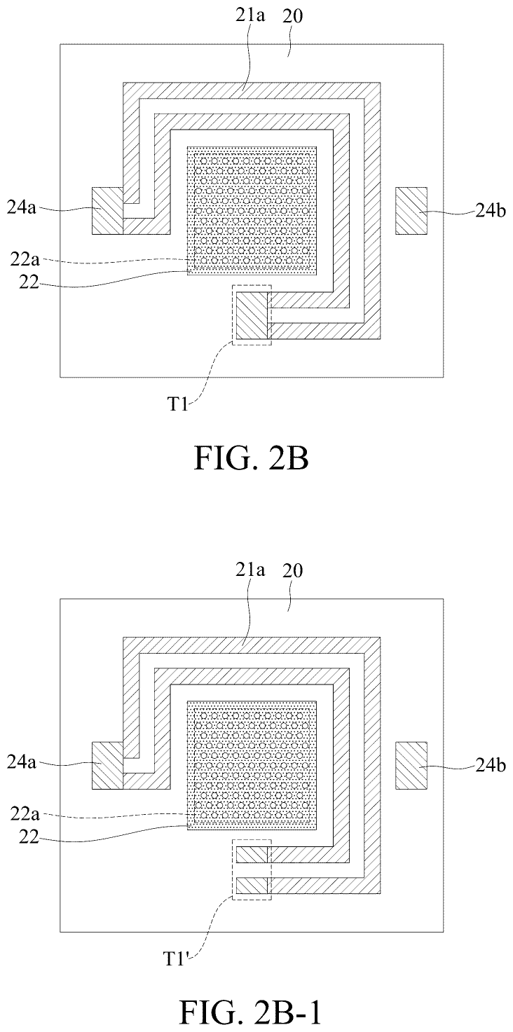

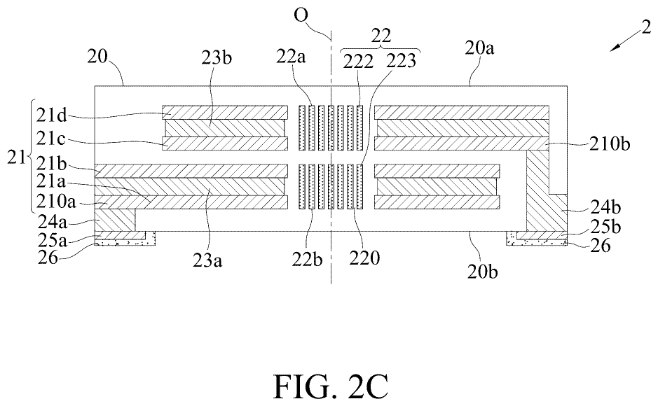

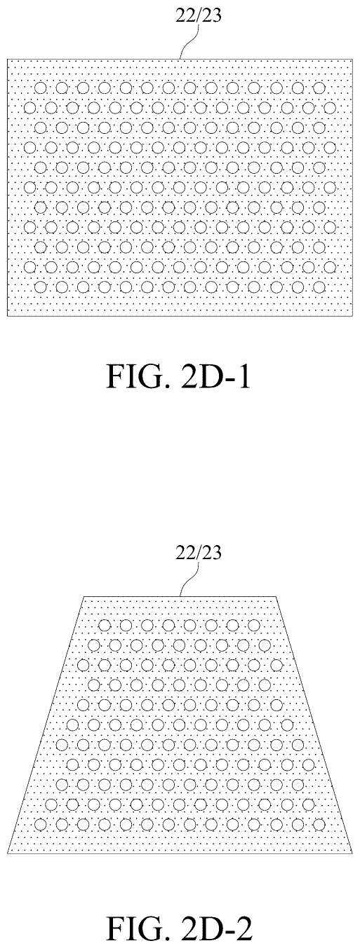

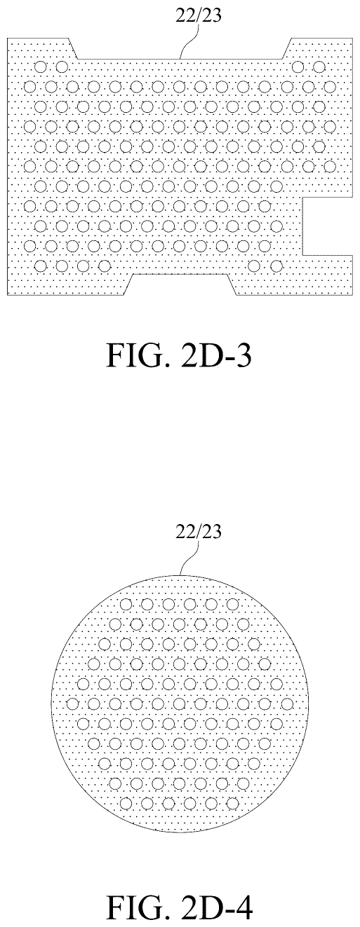

FIG. 2 is a schematic cross-sectional view showing an inductive structure 2 according to a first embodiment of the present disclosure.

As shown in FIG. 2, the inductor structure 2 is a horizontally wound structure and includes an insulator 20, an inductive body 21 surrounding a coil axis O and embedded in the insulator 20, and a magnetic core structure 22 disposed along the coil axis O and embedded in the insulator 20, such that the inductive body 21 is disposed around the magnetic core structure 22.

The insulator 20 has a first side 20a and a second side 20b opposing the first side 20a. In an embodiment, the insulator 20 is a dielectric material such as ABF (ajinomoto build-up film), photosensitive resin, polyimide (PI), bismaleimide triazine (BT), prepreg (PP) of FR5, molding compound, epoxy molding compound (EMC) or other suitable materials. The better material of the insulator 20 is PI, ABF or EMC, which is easy to process wiring processing.

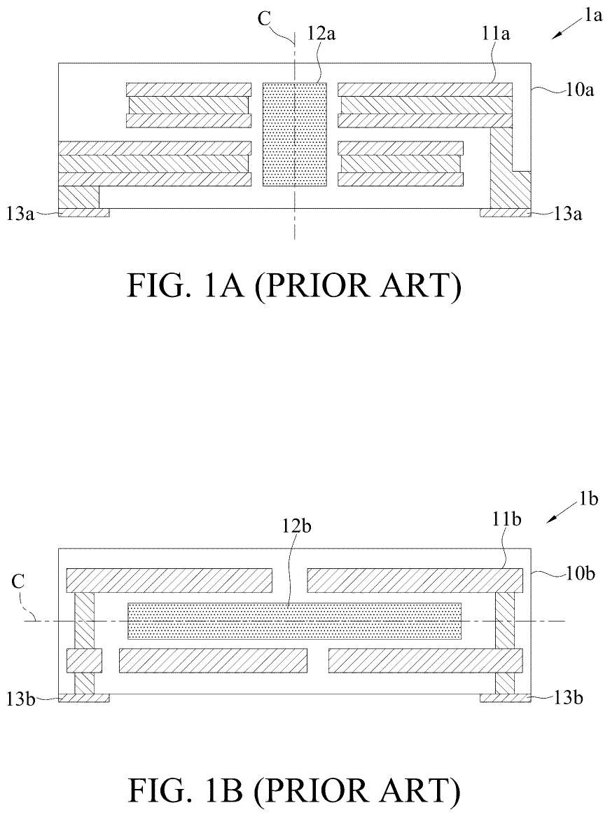

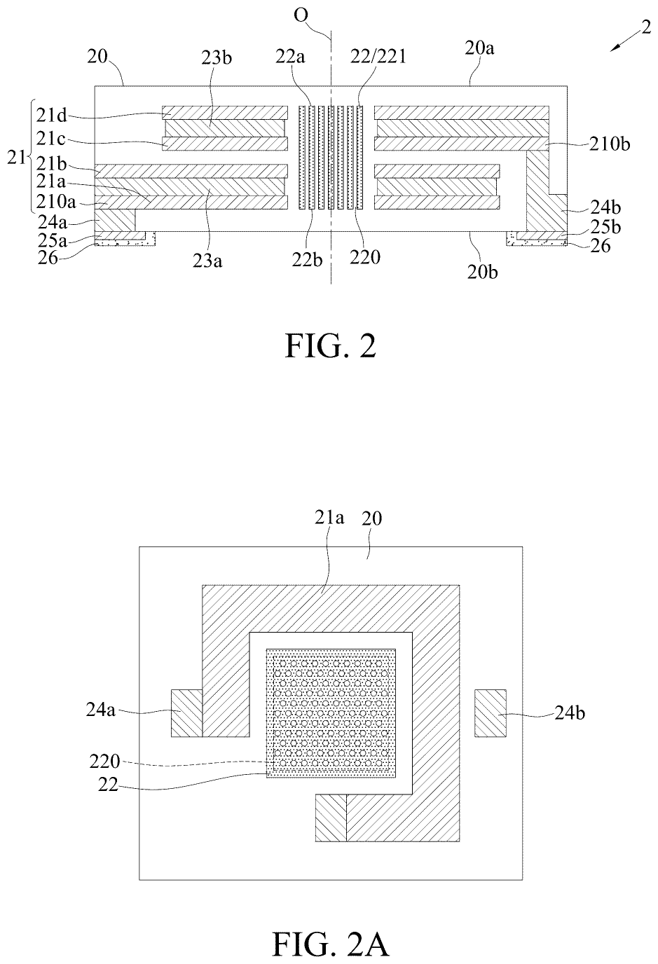

The inductive body 21 includes a plurality of inductive circuit layers 21a, 21b, 21c, 22d separated from each other and at least one conductor 23a, 23b connecting adjacent inductive circuit layers 21a, 21b, 21c, 22d. The inductive body 21 is a copper spiral coil, and the number of strands of coils can be designed according to demand. As shown in FIG. 2A, the inductive circuit layer 21a in the inductive body 21 is in the form of a single-stranded spiral coil. As shown in FIG. 2B and FIG. 2B-1, the inductive circuit layers 21a in the inductive body 21 show a multi-stranded (e.g., two-stranded) spiral coil, wherein an end T1 of the inductive circuit layer 21a which is connected to the next inductive circuit layer 21b may be presented in a connected state (as shown in FIG. 2B), or an end T1′ thereof may be presented in a separated state without connecting the two-stranded spiral coils (as shown in FIG. 2B-1). In detail, the single-stranded spiral coil design is generally preferred for circuits with frequencies above 2 MHz, while the multi-stranded spiral coil design is generally preferred for circuits with frequencies below 2 MHz.

In an embodiment, two external electrical contacts 210a, 210b of the inductive body 21 are located at the outer ends of the two inductive circuit layers 21a, 21c near the first side 20a and the second side 20b, respectively, so as to serve as an input port and an output port. For example, a first conductive pillar 24a and a second conductive pillar 24b are formed in the insulator 20 such that the first conductive pillar 24a is connected to the second side 20b of the insulator 20 and is connected to an external electrical contact 210a in the inductive circuit layer 21a, and such that the second conductive pillar 24b is connected to the second side 20b of the insulator 20 and is connected to another external electrical contact 210b in the other inductive circuit layer 21c.

Further, the end surface of the first conductive pillar 24a is connected to a first electrical contact pad 25a located on the second side 20b of the insulator 20, and the end surface of the second conductive pillar 24b is connected to a second electrical contact pad 25b located on the second side 20b of the insulator 20, such that the first electrical contact pad 25a and the second electrical contact pads 25b can be used for external connection of other electronic elements.

In addition, a surface treatment layer 26 and/or a solder material may be formed on the first electrical contact pad 25a and the second electrical contact pad 25b to facilitate the connection of other electronic elements. The material of the surface treatment layer 26 is nickel/gold (Ni/Au), nickel/palladium/gold (Ni/Pd/Au) or organic solder-protection flux (OSP), and the like.

The magnetic core structure 22 has a first surface 22a, a second surface 22b opposing the first surface 22a and a plurality of vias 220 penetrating through the first surface 22a and the second surface 22b, that is, the plurality of vias 220 extends in the direction of a connection line between the first side 20a and the second side 20b of the insulator 20.

In an embodiment, the magnetic core structure 22 is a magnetically conductive material such as at least one of iron (Fe), nickel (Ni), cobalt (Co), manganese (Mn), zinc (Zn) or a combination thereof.

Moreover, the magnetic core structure 22 is embedded in the insulator 20 along the coil axis O, and the inductive body 21 surrounds the magnetic core structure 22. In addition, the plurality of vias 220 of the magnetic core structure 22 are filled with the material of the insulator 20, and the bonding force between the magnetic core structure 22 and the insulator 20 is strengthened by means of the plurality of vias 220, thereby avoiding peeling off between the insulator 20 and the magnetic core structure 22.

In an embodiment, the magnetic core structure 22 may be a single magnetizing layer 221 (as shown in FIG. 2), or may be formed by a plurality of magnetizing layers 222, 223 (as shown in FIG. 2C). For example, the magnetizing layers 221, 222, 223 may be formed by using a patterning process to obtain the magnetic core structure 22, and the plurality of magnetizing layers 221, 222, 223 are not electrically connected to each other.

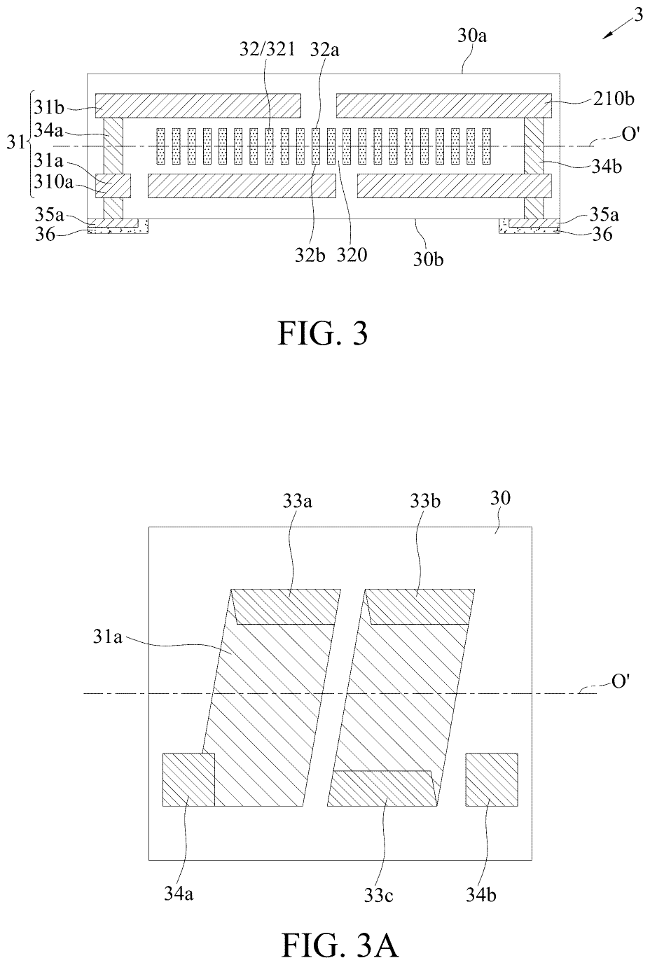

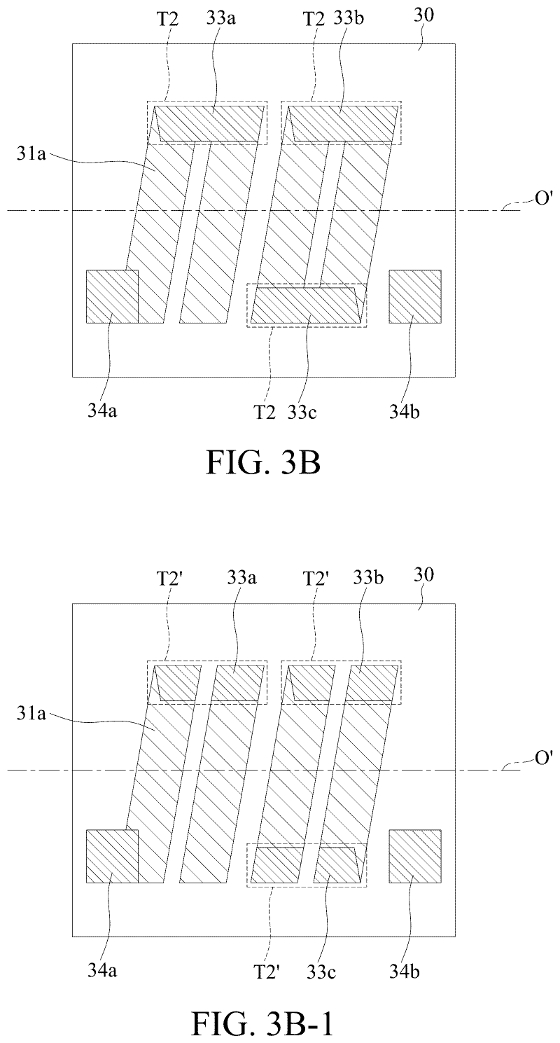

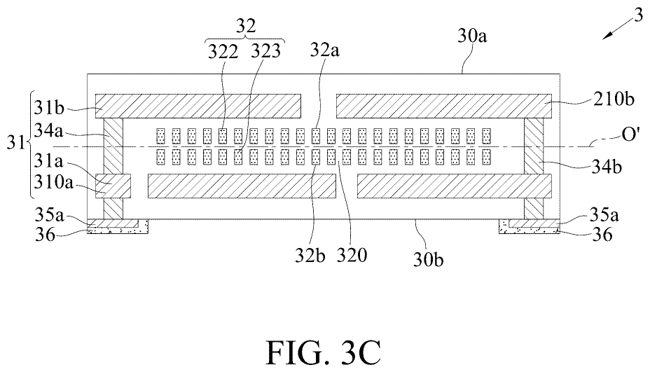

In an embodiment, as can be seen from the profile (i.e., the projected profile on the first side 20a) of the first surface 22a of the magnetic core structure 22, the magnetic core structure 22 may be in a rectangular shape, e.g., a square (as shown in FIG. 2A), a rectangle (as shown in FIG. 2D-1), or the magnetic core structure 22 may be a trapezium (as shown in FIG. 2D-2). The magnetic core structure 22 may be in a symmetric polygonal shape, or may be in an irregular polygonal shape (as shown in FIG. 2D-3). Or the profile of the magnetic core structure 22 may have a circular shape (as shown in FIG. 2D-4). Hence, the magnetic core structure 22 can enhance the bonding force between the magnetic core structure 22 and the insulator 30 by means of different shapes and profiles and to meet various design requirements.

FIG. 3 is a schematic cross-sectional view showing an inductive structure 3 according to a second embodiment of the present disclosure. Further, this second embodiment is substantially the same as the first embodiment described above, so the similarities will not be repeated.

As shown in FIG. 3, the inductive structure 3 is a vertically wound structure and includes an insulator 30, an inductive body 31 surrounding a coil axis O′ and embedded in the insulator 30, and a magnetic core structure 32 disposed along the coil axis O′ and embedded in the insulator 30, such that the inductive body 31 is disposed around the magnetic core structure 32.

The inductive body 31 has two inductive circuit layers 31a, 31b and at least one conductor 33a, 33b, 33c (shown in FIG. 3A) connecting adjacent inductive circuit layers 31a, 31b. The inductive body 31 is a copper spiral coil, and the number of strands of the coils can be designed according to demand. As shown in FIG. 3A, the inductive circuit layer 31a in the inductive body 31 is in the form of a single-stranded spiral coil. As shown in FIG. 3B and FIG. 3B-1, the inductive circuit layers 31a in the inductive body 31 show a multi-stranded (e.g., two-stranded) spiral coil, wherein a plurality of ends T2 of the inductive circuit layer 31a which are connected to the next inductive circuit layer 31b may be present in a connected state (as shown in FIG. 3B), or a plurality of ends T2′ thereof may be present in a separated state (as shown in FIG. 3B-1).

In an embodiment, two external electrical contacts 310a, 310b of the inductive body 31 are located at the outer ends of the two outermost inductive circuit layers 31a, 31b, respectively, so as to serve as an input port and an output port. For example, a first conductive pillar 34a and a second conductive pillar 34b are embedded in the insulator 30 such that the first conductor 34a is connected to the second side 30b of the insulator 30 and is connected to an external electrical contact 310a in the inductive circuit layer 31a, and such that the second conductive pillar 34b is connected to the second side 30b of the insulator 30 and is connected to another external electrical contact 310b in another inductive circuit layer 31b.

Furthermore, the end surface of the first conductive pillar 34a is connected to a first electrical contact pad 35a located on the second side 30b of the insulator 30, and the end surface of the second conductive pillar 34b is connected to a second electrical contact pad 35b located on the second side 30b of the insulator 30 such that the first electrical contact pad 35a and the second electrical contact pad 35b can be used for external connection of other electronic elements. In addition, a surface treatment layer 36 and/or a solder material may be formed on the first electrical contact pad 35a and the second electrical contact pad 35b to facilitate the connection of other electronic elements.

The magnetic core structure 32 has a first surface 32a, a second surface 32b opposing the first surface 32a, and a plurality of vias 320 penetrating through the first surface 32a and the second surface 32b, that is, the plurality of vias 320 extends in the direction of a connection line connection between the first side 30a and the second side 30b of the insulator 30. Moreover, the magnetic core structure 32 is embedded in the insulator 30 along the coil axis O′, the inductive body 31 surrounds the magnetic core structure 32, and the bonding force between the magnetic core structure 32 and the insulator 30 is strengthened by means of the plurality of vias 320. For example, the plurality of vias 320 are filled with the material of the insulator 30, thereby enhancing the bonding force between the magnetic core structure 32 and the insulator 30 and thereby avoiding peeling off between the insulator 30 and the magnetic core structure 32.

In an embodiment, the magnetic core structure 32 may be a single magnetizing layer 321 (as shown in FIG. 3), or may be formed by a plurality of magnetizing layers 322, 323 (as shown in FIG. 3C). For example, the magnetizing layers 321, 322, 323 may be formed by using a patterned process to obtain the magnetic core structure 32, and the plurality of magnetizing layers 322, 323 are not electrically connected to each other. Further, as can be seen from the profile of the first surface 32a of the magnetic core structure 32, the magnetic core structure 32 may be in a rectangular shape, e.g., a square, a rectangle (as shown in FIG. 2D-1), or the magnetic core structure 32 may be a trapezium (as shown in FIG. 2D-2). The profile of the magnetic core structure 32 may be in a symmetric polygonal shape or an irregular polygonal shape (as shown in FIG. 2D-3). Alternatively, the profile of the magnetic core structure 32 may have a circular shape (as shown in FIG. 2D-4). Therefore, the magnetic core structure 22 can enhance the bonding force between the magnetic core structure 32 and the insulator 30 by means of different shapes and profiles.

In summary, the inductive structure 2, 3 of the present disclosure can be manufactured by means of circuit board (PCB) or carrier board processing and includes an inductive body containing a plurality of inductive circuit layers and conductors, a magnetic core structure and conductive pillars, thereby allowing for easy mass production of large boards. In addition, the inductive structure 2, 3 of the present disclosure is formed by electroplating or deposition of magnetically conductive materials using a coreless patterned build-up layer circuit method, resulting in excellent control of the accuracy of the magnetic core structure 22, 32, which forms a plurality of vias in the magnetic core structure 22, 32. As such, compared to the conventional technology, the present disclosure enhances the bonding force between the magnetic core structure 22, 32 and the insulator 20, 30 by means of the magnetic core structure 22, 32 having a plurality of vias, thereby preventing the inductor structure 2,3 from peeling off.

Moreover, the present disclosure further enhances the bonding force between the magnetic core structure 22, 32 and the insulator 20, 30 by forming the surface profile of the magnetic core structure 22, 32 into a polygonal shape.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. An inductive structure, comprising:
an insulator having a first side and a second side opposing the first side;
an inductive body which is a spiral coil embedded in the insulator; and
a magnetic core structure having a plurality of vias and embedded in the spiral coil of the inductive body within the insulator, wherein the plurality of vias extend in a direction of a connection line between the first side and the second side of the insulator and penetrate the magnetic core structure.

2. The inductive structure of claim 1, wherein the magnetic core structure has a rectangular, circular, symmetrical polygonal or irregular polygonal projected profile on the first side and/or the second side of the insulator.

3. The inductive structure of claim 1, wherein the magnetic core structure is stacked in a plurality of layers at intervals, and the layers are not electrically connected to each other.

4. The inductive structure of claim 1, wherein the inductive body is a spiral coil wound horizontally or vertically.

5. The inductive structure of claim 1, wherein the inductive body comprises a plurality of inductive circuit layers spaced apart from each other and at least a conductor connecting adjacent inductive circuit layers, and two outer ends of the plurality of inductive circuit layers have external electrical contacts respectively.

6. The inductive structure of claim 5, further comprising a first conductive pillar and a second conductive pillar embedded in the insulator and respectively connected to the two external electrical contacts, wherein at least one end of the first conductive pillar is exposed to one surface of the first side or the second side of the insulator, and at least one end of the second conductive pillar is exposed to one surface of the first side or the second side of the insulator.

7. The inductive structure of claim 5, wherein the plurality of inductive circuit layers are in a form of a single-stranded spiral coil.

8. The inductive structure of claim 5, wherein the plurality of inductive circuit layers are in a form of multiple-stranded spiral coils.

9. The inductive structure of claim 8, wherein ends of the plurality of inductive circuit layers are connected.

10. The inductive structure of claim 8, wherein ends of the plurality of inductive circuit layers are separated.
